(19) United States
(12) Patent Application Publication
(10) Pub. No.: US 2009/0103311 A1
(43) Pub. Date: Apr. 23, 2009

(54) Diffuser plate, method for manufacture thereof, and backlight module and liquid crystal display using the same

(75) Inventors: Jeah-Sheng Wu, Miao-Li (TW); Yu-Ju Hsu, Miao-Li (TW); Jia-Shyong Cheng, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/286,637

(22) Filed: Sep. 30, 2008

(30) Foreign Application Priority Data
Oct. 10, 2007 (CN) 200710123812.5

(51) Int. Cl. G02B 5/02; B29D 11/00; G02B 1/00

(52) U.S. Cl. 362/311.03; 359/599; 264/1.6

(57) ABSTRACT

An exemplary diffuser plate includes a diffuser film. The diffuser film includes a plurality of diffusion particles distributed therein. A refractive index of the outer shell of each diffusion particle exceeds that of the inner surface of each diffusion particle.

### FIELD OF THE INVENTION

The present disclosure relates to a diffuser plate, and more particularly to a diffuser plate employing hollow particles and a method for manufacturing the diffuser plate. The present disclosure further relates to a backlight module and a liquid crystal display (LCD) using the diffuser plate.

### GENERAL BACKGROUND

LCDs have been widely used in various portable information products such as notebooks, personal digital assistants (PDAs), and video cameras, because of portability, low power consumption, and low radiation. A typical LCD includes an LCD panel, a backlight illuminating the LCD panel, and a diffuser plate disposed between the backlight and the LCD panel scattering light from the backlight to normalize the planar illumination.

Referring to FIG. 7, an LCD 1 includes an LCD panel 11, and a backlight module 12 facing the LCD panel 11. The backlight module 12 is configured to provide planar light to illuminate the LCD panel 11.

The backlight module 12 includes a light guide plate 13, a reflector 14, a light source 15, and a diffuser plate 16. The light guide plate 13 includes a light incident surface 131, a light emitting surface 132 adjacent to the light incident surface 131, and a bottom surface 133 opposite to the light emitting surface 132. The light source 15 is located at a side of the light incident surface 131. The reflector 14 is positioned adjacent to the bottom surface 133 to reflect light from the bottom surface 133 back to the light guide plate 13. The diffuser plate 16 is located between the light emitting surface 132 and the LCD panel 11.

The light source 15 is emitted light which enters the light guide plate 13 via the light incident surface 131. Some of the light directly reaches the diffuser plate 16 from the light emitting surface 132. Other light reaches the reflector 14 from the bottom surface 133 and is then reflected back to the light guide plate 13. Finally, other light reaching the light guide plate 13 is emitted from the light emitting surface 132 thereof and reaches the diffuser plate 16. The light is scattered by the diffuser plate 16, providing even planar illumination of the LCD panel 11.

In FIG. 8, a cross-section of the diffuser plate 16, shows the diffuser plate 16 including diffuser film 160, anti-static film 164, and base film 162 sandwiched therebetween. Diffuser film 160 includes a plurality of hemispherical protrusions 161. After leaving light emitting surface 132 of the light guide plate 13 and reaching the diffuser plate 16, the light passes through anti-static film 164 and base film 162 to reach diffuser film 160 and is then scattered by the hemispherical protrusions 161.

However, the light can only be scattered after reaching an upper surface of the hemispherical protrusions 161 and being refracted thereby. A diffusion degree of the light emitted from the diffuser plate 16 is thus low, resulting in light emitted therefrom being concentrated within a predetermined viewing angle perpendicular to the LCD panel 11, notably narrowing viewing angle of the LCD 1.

It is desired to provide a new diffuser plate which can overcome the described limitations.

### SUMMARY

A diffuser plate includes a diffuser film. The diffuser film includes a plurality of diffusion particles distributed therein. A first refractive index of the outer shell of each diffusion particle exceeds a second refractive index of the inner surface of each diffusion particle.

Other novel features and advantages will become more apparent from the following detailed description when taken in conjunction with the accompanying drawings.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, isometric exploded view of a first embodiment of an LCD, the LCD including a diffuser plate.

FIG. 2 is a cross-section of a first embodiment of a diffuser plate of the LCD of FIG. 1.

FIG. 3 is a cross-section of a second embodiment of a diffuser plate.

FIG. 4 is a cross-section of a third embodiment of a diffuser plate.

FIG. 5 is a cross-section of a fourth embodiment of a diffuser plate.

FIG. 6 is a schematic, isometric exploded view of a second embodiment of an LCD, the LCD including a diffuser plate.

FIG. 7 is a schematic, isometric exploded view of a conventional LCD, the LCD including a diffuser plate.

FIG. 8 is a cross-section of the diffuser plate of FIG. 7.

### DETAILED DESCRIPTION

Reference will now be made to the drawings to describe various embodiments in detail.

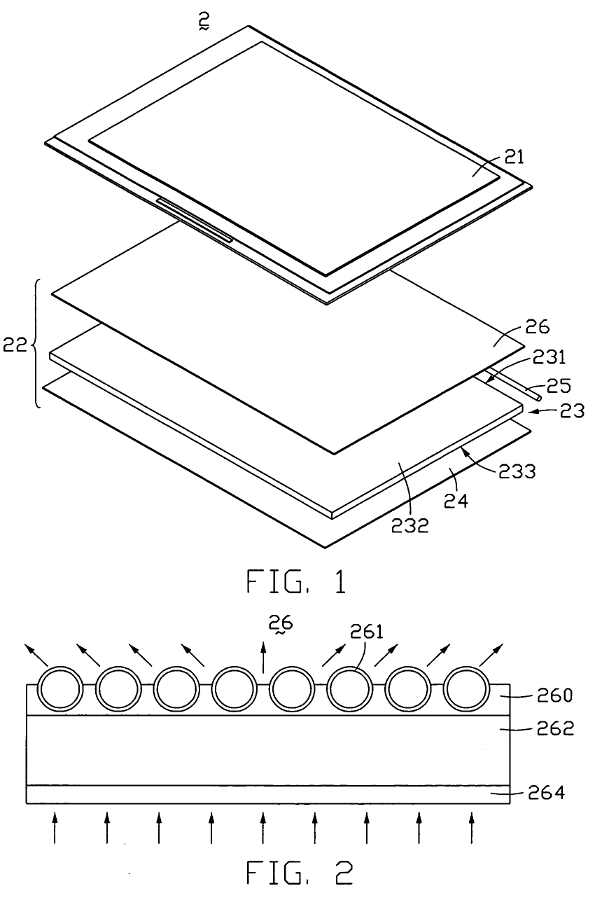

Referring to FIG. 1, a first embodiment of an LCD 2 includes an LCD panel 21 and a backlight module 22 facing and illuminating the LCD panel 21.

The backlight module 22 includes a light guide plate 23, a reflector 24, a light source 25, and a diffuser plate 26. The light guide plate 23 includes a light incident surface 231, a light emitting surface 232 adjacent to the light incident surface 231, and a bottom surface 233 opposite to the light emitting surface 232. The light source 25 is located at a side of the light incident surface 231. The reflector 24 is located adjacent to the bottom surface 233 for reflecting light back to the light guide plate 23. The diffuser plate 26, adjacent to the light emitting surface 232 is between light guide plate 23 and the LCD panel 21. The light source 25 can be a cold cathode fluorescent lamp (CCFL).

The light source 25 is emitted light into the light guide plate 23 via the light incident surface 231. Some of the light is directly emitted from the light emitting surface 232 and reaches the diffuser plate 26. Other light is emitted from the bottom surface 233 to reflector 24 and is then reflected back to the light guide plate 23. Finally, other light enters the light guide plate 23, is emitted from the light emitting surface 232 thereof, and reaches the diffuser plate 26. The light is scattered by the diffuser plate 26 providing even planar light illumination of the LCD panel 21.

Referring to FIG. 2, a cross-section of a first embodiment of a diffuser plate 26 is shown. The diffuser plate 26 includes a diffuser film 260, an anti-static film 264, and a base film 262 sandwiched therebetween. Diffuser film 260 includes a plurality of hollow balls 261, functioning as scattering particles. Part of each hollow ball 261 protrudes out of a surface of the diffuser plate 260 far from base film 262. The hollow balls 261, each the same size, are evenly arranged in a layer as shown in FIG. 2. An interval between each two adjacent hollow balls 261 is a predetermined constant such that the hollow balls 261 form an even matrix on a plane.

Diffuser film 260 can be material such as acrylic series resin. An outer shell of each hollow ball 261 can be glass or macromolecular resin. The interior of each hollow ball 261 can be filled with gas such as atmosphere or neon. Alternatively, the interior of each hollow ball 261 can be a vacuum. Anti-static film 264 can be a mixture of acrylic series resin and anti-static material. Base film 262 can be polyethylene terephthalate (PET) or polycarbonate (PC). An outer diameter of each hollow ball 261 is 5 μm˜100 μm with a preferred outer diameter of 10 μm˜30 μm. An internal diameter of each hollow ball 261 can be set according to the outer diameter of each hollow ball 261.

After the light is emitted from the light emitting surface 232 of the light guide plate 23 and reaches the diffuser plate 26, the light passes through anti-static film 264 and base film 262 to reach diffuser film 260 and is then scattered by the hollow balls 261. Because the outer and the inner surfaces of each hollow ball 261 have different refractive indices, the light not only refract or reflect at a bottom interface between the shell and the internal of each hollow ball 271 but also refract or reflect at a top interface between the shell and the internal of each hollow ball 261. Thus when the light pass through the diffuser plate 26, the light can be refracted or reflected at least twice.

Light passing through the diffuser plate 26 is refracted and reflected repeatedly by the hollow balls 261, especially due to the different refractive indices thereof. Paths of the light emitted from the diffuser plate 26 are more irregular than that from a typical diffuser plate, resulting in a substantial increase in the viewing angle of the LCD panel 21, and, accordingly, the LCD 2.

A method for manufacturing the diffuser plate 26 includes providing a base film 262, providing a dissolvent of acrylic series resin, mixing the plurality of hollow balls 261 into the dissolvent, spreading the dissolvent on a surface of the base surface 262, drying to form diffuser film 260 on the surface of base film 262, spreading a mixture of acrylic series resin and anti-static material on the other face of base film 262 opposite to diffuser film 260, and drying to form anti-static film 264.

Because the hollow balls 261 are the same size and evenly distributed on base film 262, planar light passing therethrough is resultingly uniform. Furthermore, because the interior of each hollow ball 261 is gas-filled, transparency thereof provides high efficiency of the diffuser plate 260.

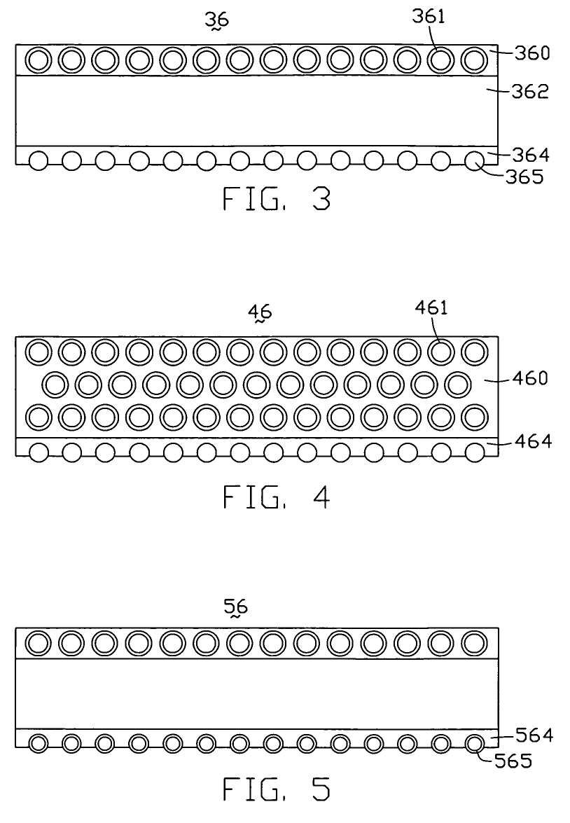

FIG. 3 is a cross-section of a second embodiment of a diffuser plate 36, differing from the previous embodiment only in that the hollow balls 361 are distributed in diffuser film 360 and do not protrude out of a surface of the diffuser plate 360. Anti-static film 364 further includes a plurality of resin balls 365. Part of the each resin ball 365 protrudes out of the surface of anti-static film 364 far from base film 362. The resin balls 365 can be polymethylmethacrylate (PMMA).

Light is first diffused by the resin balls 365 of anti-static film 364, and then by the bottom parts of the hollow balls 361, and finally by the top parts of the hollow balls 361, increasing the diffusion degree of the diffuser plate 36.

Referring to FIG. 4, a cross-section of a third embodiment of the diffuser plate 46 is shown, differing from the second embodiment only in that base film 362 is removed and diffuser film 460 further includes a plurality of layers, each including a plurality of hollow balls 461 spaced from each other. Because light is repeatedly diffused by the plurality of layers of hollow balls 461, the diffusion degree of the diffuser plate 46 is higher.

Referring to FIG. 5, a cross-section of a fourth embodiment of the diffuser plate 56 is shown, differing from the second embodiment only in that the resin balls 365 are replaced by a plurality of hollow balls 565. Part of each hollow ball 565 protrudes out of the surface of anti-static film 564.

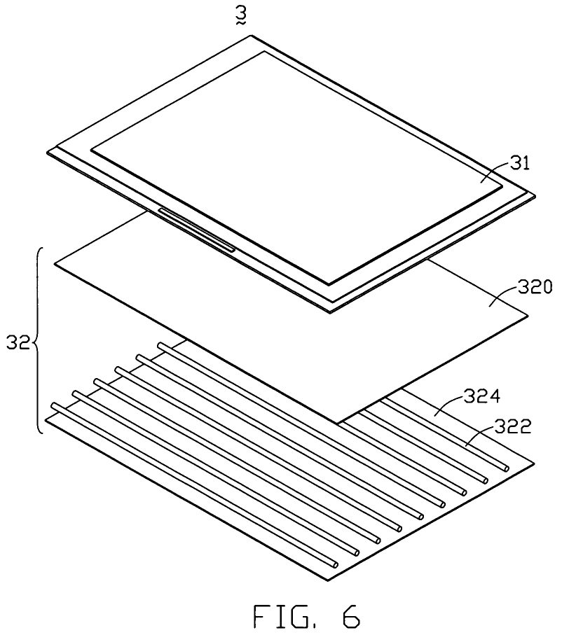

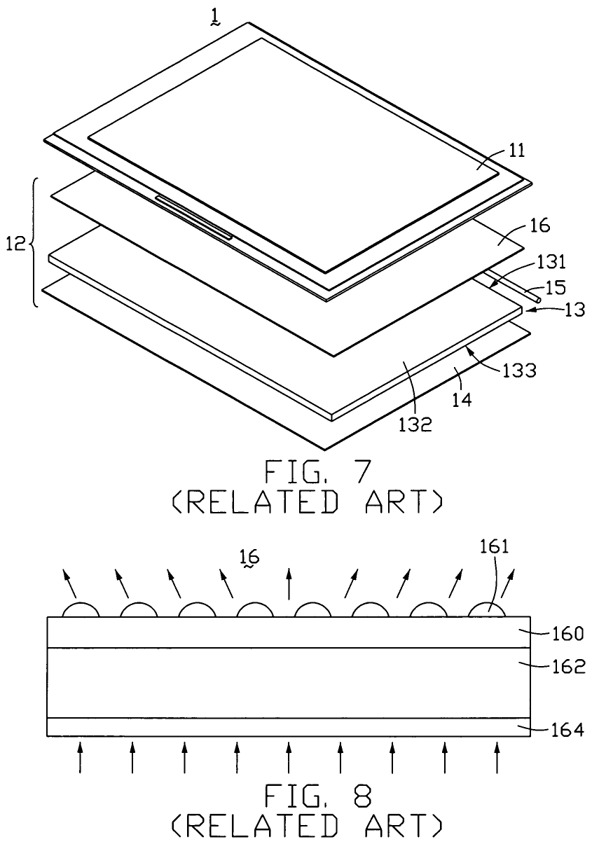

Referring to FIG. 6, a second embodiment of an LCD 3 includes an LCD panel 31 and a direct backlight module 32 facing the LCD panel 31. The backlight module 32 includes a diffuser plate 320, a reflector 324 adjacent to the diffuser plate 320, and a plurality of parallel linear lamps 322 between the reflector 324 and the diffuser plate 320. The linear lamps 322 are cold cathode fluorescent lamps.

In a third embodiment, the LCD 2 further includes a diffuser plate 26 or a typical diffuser plate located at a surface of the LCD panel 21 far from the backlight module 22, increasing viewing angle of the LCD panel 21. Alternatively, the light source 25 can be replaced by a light emitting diode (LED). Further, anti-static film 464 can be removed and anti-static materials mixed into the diffuser plate 460, reducing required steps and simplifying a method for manufacturing the diffuser plate 46.

It is to be understood, however, that even though numerous characteristics and advantages of the present disclosure have been set out in the foregoing description, together with details of the structures and functions of the embodiments, the disclosure is illustrative only; and that changes may be made in detail, especially in matters of arrangement of parts within the principles of the invention to the full extent indicated by the broad general meaning of the terms in which the appended claims are expressed.

1: A diffuser plate comprising a diffuser film, the diffuser film comprising a plurality of diffusion particles distributed therein, wherein a refractive index of the outer shell of each diffusion particle that of the inner surface of each diffusion particle.

2: The diffuser plate of claim 1, wherein the diffuser film is acrylic series resin.

3: The diffuser plate of claim 1, wherein the diffusion particles are evenly arranged in at least one layer.

4: The diffuser plate of claim 1, wherein part of each diffusion particle protrudes out of a surface of the diffuser film.

5: The diffuser plate of claim 1, wherein an outer diameter of each diffusion particle is 5 μm˜100 μm.

6: The diffuser plate of claim 1, wherein the diffusion particles are hollow balls.

7: The diffuser plate of claim 6, wherein the outer shell of each hollow ball is glass or macromolecular resin and the interior of each hollow ball is filled with gas such as atmosphere or neon.

8: The diffuser plate of claim 6, wherein the outer shell of each hollow ball is glass or macromolecular resin and the interior of each hollow ball is a vacuum.

9: The diffuser plate of claim 1, further comprising an anti-static film adjacent to the diffuser film.

10: The diffuser plate of claim 9, wherein the anti-static film a mixture of acrylic series resin and anti-static material.

11: The diffuser plate of claim 9, wherein the anti-static film comprises a plurality of hollow balls therein, and part of each hollow ball protrudes out of a surface of anti-static film.

12: The diffuser plate of claim 9, wherein the anti-static film comprises a plurality of resin balls therein, and part of each resin ball protrudes out of a surface of the anti-static film.

13: The diffuser plate of claim 12, wherein the resin balls are polymethylmethacrylate (PMMA).

14: The diffuser plate of claim 8, further comprising a base film located between the anti-static film and the diffuser film.

15: The diffuser plate of claim 11, wherein the base film is polyethylene terephthalate (PET) or polycarbonate (PC).

16: A method for manufacturing a diffuser comprising:
providing a base film, and
forming a diffuser film comprising a plurality of diffusion particles distributed on the base film,
wherein a refractive index of the outer shell of each diffusion particle exceeds that of the inner surface of each diffusion particle.

17: The method of claim 16, wherein the diffusion particles are hollow balls.

18: The method of claim 17, further comprising providing a dissolvent of acrylic series resin, mixing the plurality of hollow balls into the dissolvent, spreading the dissolvent onto a surface of the base surface; and drying to form a diffuser film on the surface of the base film.

19: A backlight module comprising a light source and a diffuser plate, the diffuser plate comprising a diffuser film comprising a plurality of diffusion particles distributed therein, wherein a refractive index of the outer shell of each diffusion particle exceeds that of the inner surface of each diffusion particle.

20. (canceled)
